(19) United States
(12) Patent Application Publication
(10) Pub. No.: US 2004/0107764 A1
(43) Pub. Date: Jun. 10, 2004

(54) System and method for measuring trace gases

(76) Inventor: Wen-Bin Yan, Cranbury, NJ (US)

Correspondence Address: RATNERPRESTIA, P O BOX 980, VALLEY FORGE, PA, 19482-0980, US

(21) Appl. No.: 10/310,091

(22) Filed: Dec. 4, 2002

(51) Int. Cl. G01N 30/02

(52) U.S. Cl. 73/23.37

(57) ABSTRACT

An apparatus and method for measuring trace gases contained in a liquid or a gas using Cavity Ring-Down Spectroscopy. The apparatus comprises a chromatograph for separating a fluid into a plurality of gaseous components, the plurality of components are output from an output port of the gas chromatograph. A cavity ring-down spectroscopy (CRDS) unit is coupled to the output port of the gas chromatograph, and the CRDS unit determines at least one level of a trace species based on at least a portion of the plurality of gaseous components provided by the chromatograph.

### FIELD OF THE INVENTION

This invention relates generally to absorption spectroscopy and, in particular, is directed to a system and method for measuring trace gases from a fluid using cavity ring-down spectroscopy.

### BACKGROUND OF THE INVENTION

A detector of a gas chromatograph (GC) continuously measures a specific physical property of the gas effluent from the column and draws a chromatogram representing the change in the specific physical property. A thermal conductivity detector (TCD) or a hydrogen flame ionization detector (FID) is typically used as a detector of a gas chromatograph system. Constituents of a sample are measured qualitatively based on the time (retention time) and quantitatively based on the height (or area) of each peak in the chromatogram. Conventional GC systems are deficient, however, because the detection of trace species is limited to parts-per-million (ppm) or sub-ppm levels.

A gas chromatograph/mass spectrometer (GC/MS), on the other hand, carries out a mass spectrometric analysis for each constituent of the sample separated by the column with a mass spectrometer (MS) and thus enables highly sensitive and accurate identification of each constituent. Although detection sensitivity may be enhanced using mass spectroscopy (MS) in combination with gas chromatography (GC/MS), it is only achieved at great expense. Further, conventional mass spectroscopy apparatus are large and difficult to interface with a convention GC apparatus.

The science of spectroscopy studies spectra. In contrast with sciences concerned with other parts of the spectrum, optics particularly involves visible and near-visible light—a very narrow part of the available spectrum which extends in wavelength from about 1 mm to about 1 nm. Near visible light includes colors redder than red (infrared) and colors more violet than violet (ultraviolet). The range extends just far enough to either side of visibility that the light can still be handled by most lenses and mirrors made of the usual materials. The wavelength dependence of optical properties of materials must often be considered.

In contrast to mass spectroscopy, absorption-type spectroscopy offers high sensitivity, response times on the order of microseconds, immunity from poisoning, and limited interference from molecular species other than the species under study. Various molecular species can be detected or identified by absorption spectroscopy. Thus, absorption spectroscopy provides a general method of detecting important trace species. In the gas phase, the sensitivity and selectivity of this method is optimized because the species have their absorption strength concentrated in a set of sharp spectral lines. The narrow lines in the spectrum can be used to discriminate against most interfering species.

In many industrial processes, the concentration of trace species in flowing gas streams and liquids must be measured and analyzed with a high degree of speed and accuracy. Such measurement and analysis is required because the concentration of contaminants is often critical to the quality of the end product. Gases such as N₂, O₂, H₂, Ar, and He are used to manufacture integrated circuits, for example, and the presence in those gases of impurities—even at parts per billion (ppb) levels—is damaging and reduces the yield of operational circuits. Therefore, the relatively high sensitivity with which water and other trace species can be spectroscopically monitored is important to manufacturers of high-purity gases used in the semiconductor industry. Various impurities must be detected in other industrial applications. Further, the presence of impurities, either inherent or deliberately placed, in liquids have become of particular concern of late.

Spectroscopy has obtained parts per million (ppm) level detection for gaseous contaminants in high-purity gases. Detection sensitivities at the ppb level are attainable in some cases. Accordingly, several spectroscopic methods have been applied to such applications as quantitative contamination monitoring in gases, including: absorption measurements in traditional long pathlength cells, photoacoustic spectroscopy, frequency modulation spectroscopy, and intracavity laser absorption spectroscopy.

Continuous wave-cavity ring-down spectroscopy (CW-CRDS) has become an important spectroscopic technique with applications to science, industrial process control, and atmospheric trace gas detection. CW-CRDS has been demonstrated as a technique for the measurement of optical absorption that excels in the low-absorbance regime where conventional methods have inadequate sensitivity. CW-CRDS utilizes the mean lifetime of photons in a high-finesse optical resonator as the absorption-sensitive observable.

Typically, the resonator is formed from a pair of nominally equivalent, narrow band, ultra-high reflectivity dielectric mirrors, configured appropriately to form a stable optical resonator. Laser photons are injected into the resonator through a mirror to experience a mean lifetime which depends upon the length of the resonator, the absorption cross section and number density of the species, and a factor accounting for intrinsic resonator losses (which arise largely from the frequency-dependent mirror reflectivities when diffraction losses are negligible). The determination of optical absorption is transformed, therefore, from the conventional power-ratio measurement to a measurement of decay time. The ultimate sensitivity of CW-CRDS is determined by the magnitude of the intrinsic resonator losses, which can be minimized with techniques such as superpolishing that permit the fabrication of ultra-low-loss optics.

The aforementioned CRDS (and CW-CRDS) method works well because the pathlength of gases in a CRDS cell is very long, and the resulting sensitivity is ppb to sub-ppb levels. If there are many gas components existing in the sample gas, however, their spectra may interfere with each other resulting in a degradation of sensitivity.

To overcome the shortcomings of conventional detection systems, an improved system and method for measuring the presence and level of trace species in a fluid is needed.

### SUMMARY OF THE INVENTION

To achieve that and other objects, and in view of its purposes, the present invention provides an improved apparatus and method for measuring the presence and level of trace gases from a gas chromatograph. The apparatus includes a chromatograph for separating a fluid into a plurality of gaseous components, the plurality of components output from an output port of the gas chromatograph; and a cavity ring-down spectroscopy unit coupled to the output port of the gas chromatograph, where the cavity ring-down spectroscopy unit determines at least one level of a trace species based on at least a portion of the plurality of gaseous components provided by the chromatograph.

According to another aspect of the invention, the chromatograph is a gas chromatograph and the fluid is a gas.

According to a further aspect of the invention, the chromatograph is a liquid chromatograph and the fluid is a liquid.

According to yet another aspect of the invention, a method for analyzing traces gases in a fluid comprises the steps of separating the fluid into a plurality of gaseous components; providing the plurality of gaseous components to a cavity ring-down spectroscopy unit; and determining at least one level of a trace species based on at least a portion of the plurality of gaseous components provided to the cavity ring-down spectroscopy unit.

According to still another aspect of the invention, the gaseous components are heated before being provided to the cavity ring-down spectroscopy unit.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 illustrates an exemplary embodiment of the present invention; and

FIG. 2 illustrates another exemplary embodiment of the present invention.

### DETAILED DESCRIPTION OF THE INVENTION

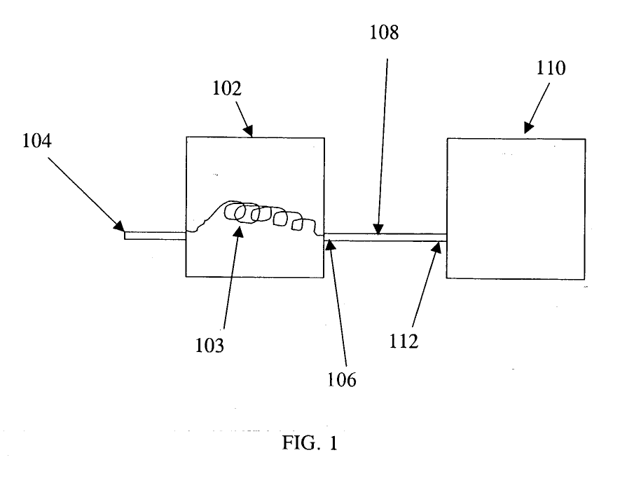

Referring now to the drawing, wherein like reference numerals refer to like elements throughout, FIG. 1 is an exemplary embodiment of the present invention. As shown in FIG. 1, system 100 includes chromatograph 102 and CRDS cell 110. Chromatograph 102 may be a gas chromatograph (GC) or a liquid chromatograph (LC). A fluid (not shown) is introduced into input port 104 of chromatograph 102. Within chromatograph 102, and as understood by those of skill in the art, column 103 disassembles the fluid into gaseous components (not shown) which are in turn output at output port 106. Coupling 108 is connected between output port 106 and input port 112 of CRDS cell 110. The gaseous components are provided to CRDS cell 110 and the level of traces species contained within the gaseous components is determined using convention means, such as a processor (not shown) coupled to CRDS cell 110.

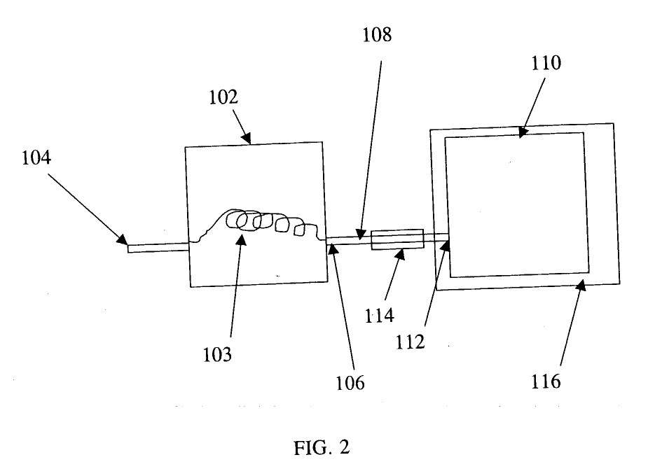

As shown in FIG. 2, according to another exemplary embodiment of the present invention, to maintain the gas in a gas phase, coupling 108 between outlet 106 of chromatograph 102 and inlet 112 of CRDS cell 110, as well as CRDS cell 110, may be heated. This heating can be done using heating tapes 114 wrapped around the coupling 108 and CRDS cell 110, or using ovens 116 that provide a heated environment around CRDS cell 110 and/or coupling 108, for example.

Although chromatograph 102 and CRDS cell 110 are shown as separate components. it is possible to combine then into a single unit if desired.

This approach has advantages over the prior art current GC/LC methods by increasing the sensitivity for trace gas detection. Further, this exemplary approach has the capability to resolve gas species with overlapping spectra.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

What is claimed is:

1. A system for trace gas analysis, comprising:
a chromatograph for separating a fluid into a plurality of gaseous components, the plurality of components output from an output port of the gas chromatograph; and
a cavity ring-down spectroscopy unit coupled to the output port of the gas chromatograph;
wherein the cavity ring-down spectroscopy unit determines at least one level of a trace species based on at least a portion of the plurality of gaseous components provided by the chromatograph.

2. The system according to claim 1, wherein the chromatograph is a gas chromatograph and the fluid is a gas.

3. The system according to claim 1, wherein the chromatograph is a liquid chromatograph and the fluid is a liquid.

4. The system according to claim 1, further comprising a coupling between the output port of the chromatograph and an input of the cavity ring-down spectroscopy unit.

5. The system according to claim 4, wherein the coupling includes a heater to maintain the plurality of components in a gaseous state.

6. The system according to claim 5, wherein the heater is one of an oven and a heating tape.

7. A method for trace gas analysis, the method comprising the steps of:
separating a fluid into a plurality of gaseous components;
providing the plurality of gaseous components to a cavity ring-down spectroscopy unit; and
determining at least one level of a trace species based on at least a portion of the plurality of gaseous components provided to the cavity ring-down spectroscopy unit.

8. The method according to claim 7, further comprising the step of heating the gaseous components provided to the cavity ring-down spectroscopy unit.

9. The method according to claim 7, wherein the fluid is a liquid.

10. The method according to claim 7, wherein the fluid is a gas.

11. A system for trace gas analysis, comprising:
a chromatograph for separating a fluid into a plurality of gaseous components, the plurality of components output from an output port of the gas chromatograph; and
a cavity ring-down spectroscopy unit coupled to the output port of the gas chromatograph;
wherein the cavity ring-down spectroscopy unit determines at least one level of a trace species based on each of the plurality of gaseous components provided by the chromatograph.

12. A method for trace gas analysis, the method comprising the steps of:
separating a fluid into a plurality of gaseous components;
providing the plurality of gaseous components to a cavity ring-down spectroscopy unit; and
determining at least one level of a trace species based on each of the plurality of gaseous components provided to the cavity ring-down spectroscopy unit.
